(19) United States
(12) Patent Application Publication
(10) Pub. No.: US 2009/0235744 A1
(43) Pub. Date: Sep. 24, 2009

(54) Detecting device for a walk-substituting cart to automatically slow down when moving down slope

(76) Inventor: Ming-Hung Tsai, Chia Yi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/076,371

(22) Filed: Mar. 18, 2008

(51) Int. Cl. G01P 15/02

(52) U.S. Cl. 73/514.02

(57) ABSTRACT

A walk-substituting cart is equipped with a detecting device, which can detect the existence and measure the inclination of a downward slope that the walk-substituting cart is moving on; when the cart is moving down a slope, the detecting device will send a signal to a power source of the walk-substituting cart so that the power source can automatically slow down; therefore, the rider won't have to continue operating the brake lever or the brake pedal of the walk-substituting cart a long time when the cart is moving down a slope.

### BACKGROUND OF THE INVENTION

1. Field of the Invention

The present invention relates to a detecting device of a walk-substituting cart, more particularly one, which will switch on for the walk-substituting cart to automatically reduce its speed on a downward slope, and which allows the brake mechanism of the cart to automatically start functioning on a slope of relatively large inclination.

2. Brief Description of the Prior Art

Electric walk-substituting carts are usually used by the elderly and physically disabled persons. When such a walk-substituting cart is moving down a slope, it will move faster and faster to cause danger if the rider doesn't use the brake lever/pedal of the cart. And, it is relatively difficult for an elderly or physically disabled rider to continue pressing the brake lever/pedal with a proper amount of force a long time when the cart is moving down a slope. Therefore, the walk-substituting cart can fall over when moving down a slope.

The industry develops a warning device, which is installed on a walk-substituting cart to warn the rider if the rider has ridden the cart onto a relatively deeply inclined slope. The warning device includes a central processor, an inclination detecting and measuring unit, and a warning unit; the central processor includes an inclination comparison circuit, and an amplifier, which are connected to the inclination detecting and measuring unit, and the warning unit respectively. The inclination detecting and measuring unit includes a holding member, a rolling bead in the holding member, a photoelectric switch, and a light source above the photoelectric switch; the rolling bead usually blocks light beams from the light source, and will roll away for light beams of the light source to switch on the photoelectric switch if the walk-substituting cart has moved onto a slope of relatively large inclination; thus, the inclination detecting and measuring unit will send a signal to the central processor, and in turn the warning unit will produce signals to warn the rider off the deeply inclined slope.

However, the rider will have to turn around or back the walk-substituting cart on a relatively inclined slope because the warning device can't detect the slope until the cart moves thereon; because it isn't very easy for the elderly and physically disabled persons to do so, danger still can happen. Therefore, the walk-substituting cart still isn't safe to ride down slope even if it is equipped with the warning device.

Therefore, it is a main object of the present invention to provide a detecting device to a walk-substituting cart to overcome the above problems, which will switch on for the cart to automatically reduce its speed on a downward slope.

### SUMMARY OF THE INVENTION

A detecting device in accordance with an embodiment of the present invention is installed on a walk-substituting cart, and connected to a power source of the cart. The detecting device can detect the existence and measure the inclination of a downward slope that the walk-substituting cart is moving on; when the cart is moving down a slope, the detecting device will send a signal to the power source so that the power source can automatically slow down. Therefore, the rider won't have to continue operating the brake lever or the brake pedal of the walk-substituting cart a long time when the cart is moving down a slope.

### BRIEF DESCRIPTION OF THE DRAWINGS

The present invention will be better understood by referring to the accompanying drawings, wherein:

FIG. 1 is a perspective view of a walk-substituting cart according to the present invention,

FIG. 2 is a side view of the walk-substituting cart,

FIG. 3 is a side view of the walk-substituting cart going downhill,

FIG. 4 is a view of a first preferred embodiment of the detecting device in the present invention,

FIG. 5 is a view of the first preferred embodiment, taken when the cart is going downhill,

FIG. 6 is a view of a second preferred embodiment,

FIG. 7 is a view of the second preferred embodiment, taken when the cart is going downhill,

FIG. 8 is a view of a third preferred embodiment, and

FIG. 9 is a view of the third preferred embodiment, taken when the cart is going downhill.

### DETAILED DESCRIPTION OF THE PREFERRED EMBODIMENTS

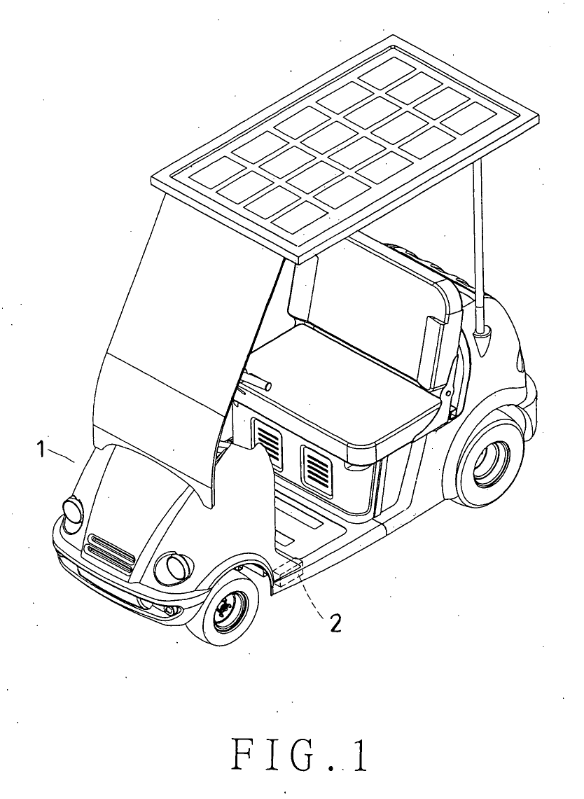

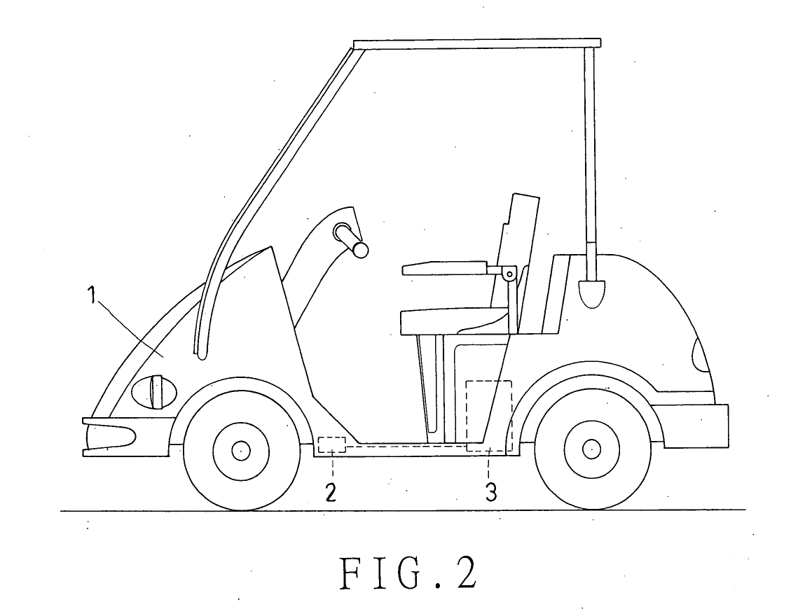

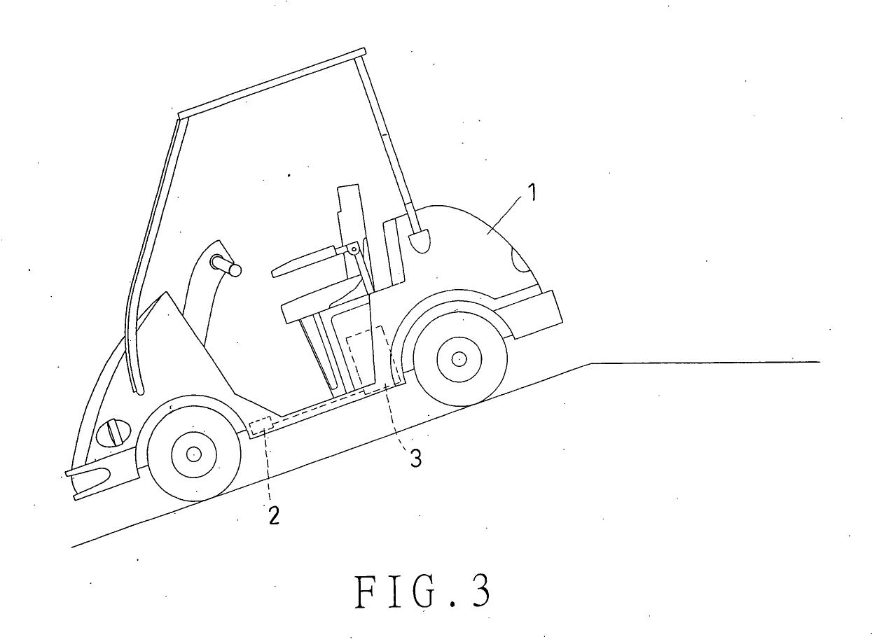

Referring to FIGS. 1 to 3, a walk-substituting cart 1 in accordance with the present invention is equipped with a detecting device 2, which can detect the existence and measure the inclination of a downward slope that the walk-substituting cart 1 is moving on. And, when the cart 1 is moving downhill, the detecting device 2 will send a signal to a power source 3 of the walk-substituting cart 1 so that the power source 3 can automatically slow down. The detecting device 2 can be installed on a footrest board of the cart 1.

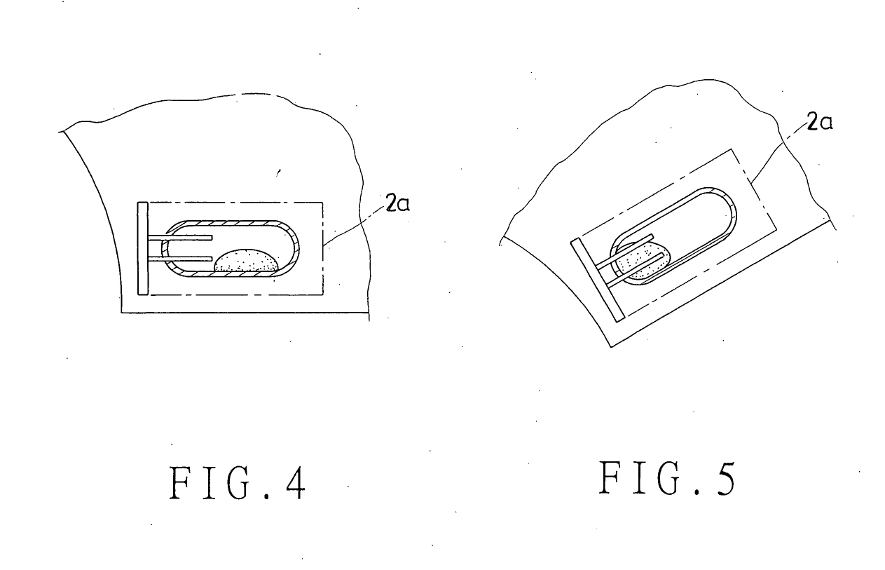

Shown in FIGS. 4 and 5 is a first preferred embodiment of the detecting device 2 of the present invention, which is a mercury switch (2a). The mercury switch (2a) contains a mercury lump, which will move to such a contacting position as to switch on the mercury switch (2a) in order for the mercury switch (2a) to send a signal to the power source 3 when the walk-substituting cart 1 is moving downhill; thus, the power source 3 begins to decelerate. Furthermore, at the same time, the mercury switch (2a) will measure the inclination of the downward slope so that the brake mechanism of the cart 1 will be automatically actuated if the inclination of the slope is relatively large. Therefore, the rider of the cart 1 won't have to continue operating the brake lever or the brake pedal of the cart 1 when the cart 1 is moving down a slope; in other words, the present invention can provide more safety and convenience to the rider.

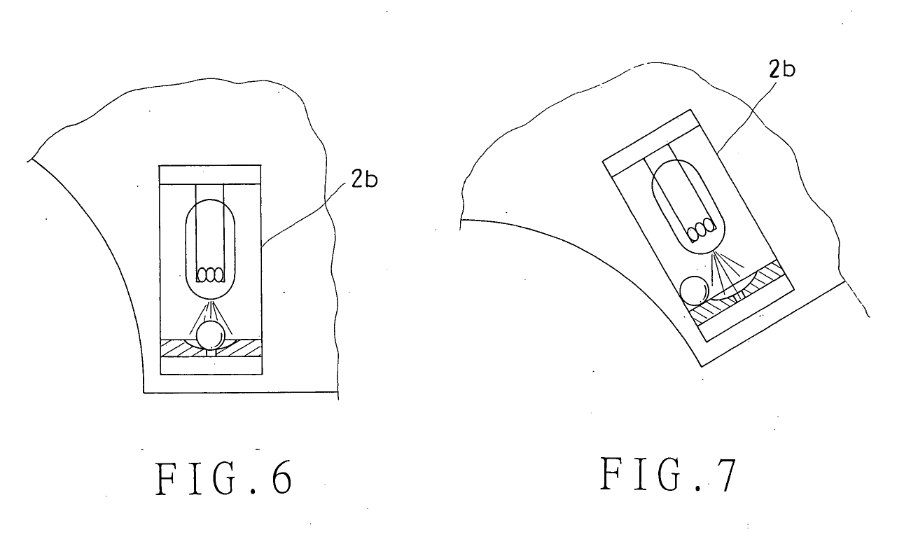

Shown in FIGS. 6 and 7 is a second preferred embodiment of the detecting device 2 of the present invention, which is a rolling bead switch (2b). The rolling bead switch (2b) includes a bead, which will roll to such a position as to switch on the rolling bead switch (2b) when the walk-substituting cart 1 is moving downhill; thus, the rolling bead switch (2b) will send a signal to the power source 3 for the power source 3 to slow down. Furthermore, the rolling bead switch (2b) will measure the inclination of the slope so that the brake mechanism of the cart 1 can be automatically actuated if the slope has a very large inclination.

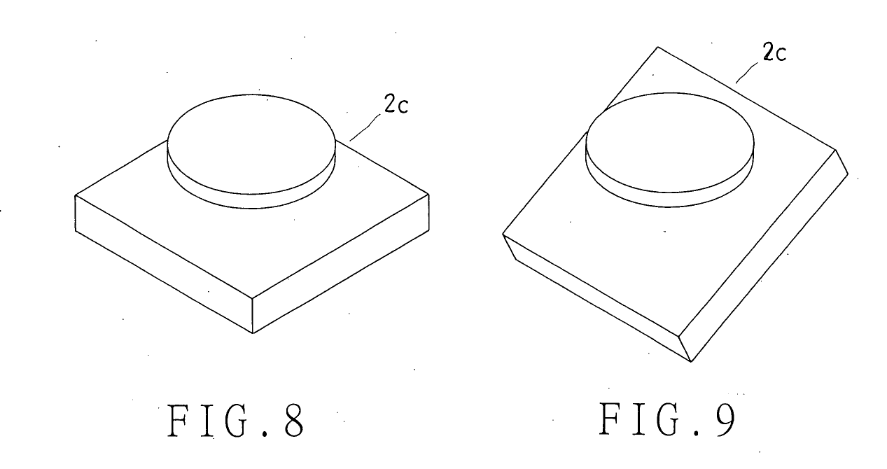

Shown in FIGS. 8 and 9 is a third preferred embodiment of the detecting device 2 of the present invention, which is a gyroscope (2c). The gyroscope (2c) will move into a tilted position as to switch on and send a signal to the power source 3 for the power source 3 to automatically slow down when the walk-substituting cart 1 is moving down a slope. Furthermore, the brake mechanism of the cart 1 will be automatically actuated if the cart 1 is moving down a slope with a very large inclination.

The detecting device 2 can be a tilt switch, which will move into a tilted position as to switch on to send a signal to the power source 3 for the power source 3 to automatically slow down when the cart 1 is moving down a slope. Furthermore, the brake mechanism of the cart 1 will be automatically actuated if the cart 1 is moving down a slope with a very large inclination.

From the above description, it can be seen that the present invention has the following advantages over the prior art:

1. When one is riding the walk-substituting cart with the detecting device of the present invention down slope, he/she won't have to continue operating the brake mechanism of the cart a long time. Therefore, the present invention provides more safety and convenience to the rider.

2. The detecting device of the present invention will measure the inclination of a slope that the walk-substituting cart is moving down so that the brake mechanism of the cart can be automatically actuated if the inclination of the slope is relatively large.

What is claimed is:

1. A detecting device for a walk-substituting cart to slow down when moving down a slope,
the detecting device being installed on a walk-substituting cart to respond to a downward slope that the cart is moving along, thus sending a signal in order for a power source of the walk-substituting cart to decelerate.

2. The detecting device for a walk-substituting cart to slow down when moving down a slope as claimed in claim 1, wherein the detecting device measures an inclination of a downward slope, and an amount of speed reduction of the power source varies with the inclination of the downward slope.

3. The detecting device for a walk-substituting cart to slow down when moving down a slope as claimed in claim 1, wherein the detecting device is a mercury switch including a mercury lump capable of changing position in response to an inclination of a slope.

4. The detecting device for a walk-substituting cart to slow down when moving down a slope as claimed in claim 1, wherein the detecting device is a switch with a rolling bead capable of changing position in response to an inclination of a slope.

5. The detecting device for a walk-substituting cart to slow down when moving down a slope as claimed in claim 1, wherein the detecting device is a gyroscope.

6. The detecting device for a walk-substituting cart to slow down when moving down a slope as claimed in claim 1, wherein the detecting device is a tilt switch.
